(19) United States
(12) Patent Application Publication
(10) Pub. No.: US 2020/0089867 A1
(43) Pub. Date: Mar. 19, 2020

(54) SYSTEM AND METHOD FOR AUTHENTICATION

(71) Applicant: SAMSUNG SDS CO., LTD., Seoul (KR)

(72) Inventors: Dong-Ho KIM, Seoul (KR); Seung-Hoon CHA, Seoul (KR); Pan-Young KIM, Seoul (KR); Jae-Hyuk CHO, Seoul (KR)

(21) Appl. No.: 16/572,858

(22) Filed: Sep. 17, 2019

(30) Foreign Application Priority Data
Sep. 17, 2018 (KR) 10-2018-0110700

(51) Int. Cl. G06F 21/45; G06F 21/32; H04L 9/32

(52) U.S. Cl. CPC G06F 21/45; G06F 2221/2103; H04L 9/3271; G06F 21/32

(57) ABSTRACT

An authentication system and method are provided. The authentication method in accordance with one embodiment includes: storing a first authentication request message received from an authentication server, generating a new challenge using a previous challenge used in a previous authentication process when a network connection to the authentication server is not possible, generating a second and newer authentication request message by replacing a challenge included in the first authentication request message with the new challenge, generating an authentication assertion by performing biometric authentication using the second authentication request message and storing the generated authentication assertion.

### CROSS-REFERENCE TO RELATED APPLICATION AND CLAIM OF PRIORITY

This application claims the benefit under 35 USC § 119(a) of Korean Patent Application No. 10-2018-0110700, filed on Sep. 17, 2018, in the Korean Intellectual Property Office, the entire disclosure of which is incorporated herein by reference for all purposes.

### BACKGROUND

### 1. Field

The following description relates to a user authentication technology.

### 2. Description of Related Art

Fast IDentity Online (FIDO) is a user authentication framework proposed by the FIDO Alliance for the purpose of solving password problems, and is mainly used for application of biometric authentication, such as fingerprint and iris scanning. The FIDO protocol has many advantages in security, compared to the existing authentication method and hence has been recently applied to various fields.

Meanwhile, development in technology has made online access possible in most areas. However, there are still areas where online access is not possible for various reasons, such as safety or security reasons, economic reasons, or lack of relevant infrastructure. For example, in the case of an office worker who frequently goes on a long-distance business trip, online access from inside of an airplane is mostly impossible. The FIDO protocol presupposes authentication in an online environment. Thus, if a work system of a company is configured to perform user authentication using the FIDO protocol, user authentication is not possible in an offline environment, such as inside of an airplane, and hence there is an inconvenience in that a user cannot conduct company work.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The disclosed embodiments are intended to provide a technical means to allow user authentication to be performed by applying a fast identity online (FIDO) protocol in an offline environment where online access is not possible.

In one general aspect, there is provided an authentication method which is performed by a terminal device comprising one or more processors and a memory in which one or more programs to be executed by the one or more processors are stored, the authentication method including: storing an authentication request message received from an authentication server; generating a new challenge using a previous challenge used in a previous authentication process with the authentication server when a network connection to the authentication server is not possible; generating a new authentication request message by replacing a challenge included in the authentication request message with the new challenge; performing biometric authentication using the new authentication request message; and storing an authentication assertion generated as a result of the biometric authentication.

The generating of the new challenge may include generating the new challenge by encrypting a string including the previous challenge, a sign count corresponding to the terminal device, and a generation time of the new challenge.

The generating of the new authentication request message may further include adding the generation time and an identifier for indicating that a current authentication type is pre-online authentication to the new authentication request message.

The identifier and the generation time may be added to an extension area of the new authentication request message.

When a previously generated authentication assertion does not exist in the terminal device, the generating of the new challenge may further include extracting the previous challenge from the stored authentication request message.

When there are one or more previously generated authentication assertions in the terminal device, the generating of the new challenge may further include extracting the previous challenge from the last authentication assertion among the one or more previously generated authentication assertions.

The storing of the authentication assertion may further include encrypting the authentication assertion.

In another general aspect, there is provided an authentication method which is performed by a server device comprising one or more processors and a memory in which one or more programs to be executed by the one or more processors are stored, the authentication method including: receiving, from a terminal, an authentication assertion for authentication of a user of the terminal; generating a new challenge using time information included in the authentication assertion and a previous challenge used in a previous authentication process with the terminal; verifying the authentication assertion using the new challenge; and transmitting an authentication result for the user of the terminal to the terminal based on a result of the verification of the authentication assertion.

The receiving of the authentication assertion may include receiving an encrypted authentication assertion from the terminal and decrypting the encrypted authentication assertion.

When a plurality of authentication assertions are received from the terminal, the method may include repeating sequentially generating the new challenge according to a generation order of each of the plurality of authentication assertions and verifying the authentication assertion.

In still another general aspect, there is provided a terminal device including: one or more processors; a memory; and one or more programs stored in the memory and, wherein the one or more programs include one or more instructions that, when executed by the one or more processors, causes the one or more processors to perform operations comprising: storing an authentication request message received from an authentication server; generating a new challenge using a previous challenge used in a previous authentication process with the authentication server when a network connection to the authentication server is not possible; generating a new authentication request message by replacing a challenge included in the authentication request message with the new challenge; performing biometric authentication using the new authentication request message; and storing an authentication assertion generated as a result of the biometric authentication.

The generating of the new challenge may include generating the new challenge by encrypting a string including the previous challenge, a sign count corresponding to the terminal device, and a generation time of the new challenge.

The generating of the new authentication request message may further include adding the generation time and an identifier for indicating that a current authentication type is pre-online authentication to the new authentication request message.

The identifier and the generation time may be configured to be added to an extension area of the new authentication request message.

When a previously generated authentication assertion does not exist in the terminal device, the generating of the new challenge may further include extracting the previous challenge from the stored authentication request message.

When there are one or more previously generated authentication assertions in the terminal device, the generating of the new challenge may further include extracting the previous challenge from the last authentication assertion among the one or more previously generated authentication assertions.

The storing of the authentication assertion may further include encrypting the authentication assertion.

In yet another general aspect, there is provided a server device including: one or more processors; a memory; and one or more programs stored in the memory, wherein the one or more programs include one or more instructions that, when executed by the one or more processors, causes the one or more processors to perform operations comprising: receiving, from a terminal, an authentication assertion for authentication of a user of the terminal; generating a new challenge using time information included in the authentication assertion and a previous challenge used in a previous authentication process with the terminal; verifying the authentication assertion using the new challenge; and transmitting an authentication result for the user of the terminal to the terminal based on a result of the verification of the authentication assertion.

The receiving of the authentication assertion may include receiving an encrypted authentication assertion from the terminal and decrypting the encrypted authentication assertion.

When a plurality of authentication assertions are received from the terminal in a process of receiving the authentication assertion, the operations may comprise repeating sequentially generating the new challenge according to a generation order of each of the plurality of authentication assertions and verifying the authentication assertion.

Other features and aspects will be apparent from the following detailed description, the drawings, and the claims.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram for describing an authentication system according to one embodiment;

FIG. 2 is a flowchart for describing an online authentication process in an authentication method according to one embodiment;

FIG. 3 is a flowchart for describing a pre-online authentication process according to one embodiment;

FIG. 4 is a flowchart for describing a pre-online authentication process according to another embodiment;

FIG. 5 is a flowchart for describing a pre-online authentication process according to one embodiment; and

FIG. 6 is a block diagram for describing a computing environment including a computing device suitable to be used in exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

Descriptions of well-known functions and constructions may be omitted for increased clarity and conciseness. Also, terms described in below are selected by considering functions in the embodiment and meanings may vary depending on, for example, a user or operator's intentions or customs. Therefore, definitions of the terms should be made on the basis of the overall context. The terminology used in the detailed description is provided only to describe embodiments of the present disclosure and not for purposes of limitation. Unless the context clearly indicates otherwise, the singular forms include the plural forms. It should be understood that the terms “comprises” or “includes” specify some features, numbers, steps, operations, elements, and/or combinations thereof when used herein, but do not preclude the presence or possibility of one or more other features, numbers, steps, operations, elements, and/or combinations thereof in addition to the description.

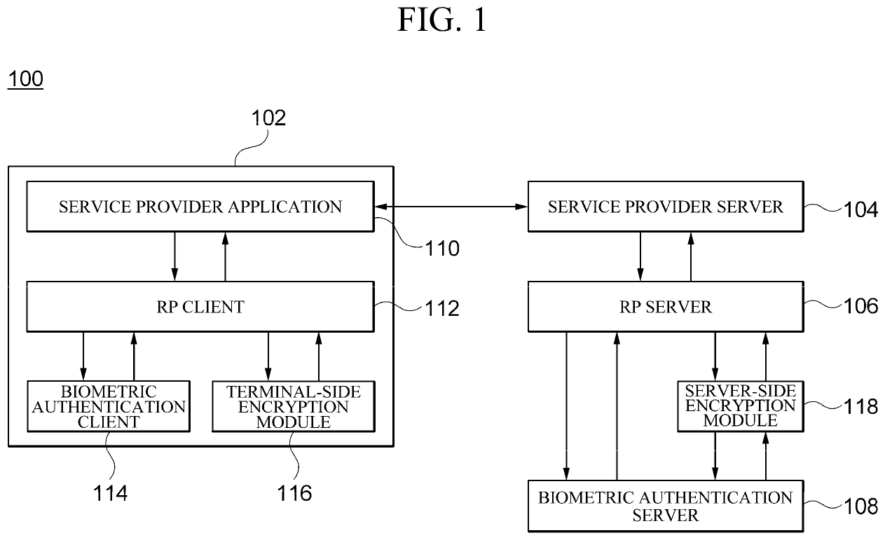

FIG. 1 is a block diagram for describing an authentication system 100 according to one embodiment. As shown in FIG. 1, the authentication system 100 according to one embodiment includes a terminal 102, a service provider server 104, a relying party (RP) server 106, and a biometric authentication server 108.

The terminal 102 is a device to be provided with a service from the service provider server 104. In one embodiment, the terminal 102 may include all types of user devices, such as desktop computers, laptop computers, smartphones, tablet computers, wearable devices, and the like, which are equipped with a computing functions and are accessible to the service provider server 104 through a network. In addition, in the disclosed embodiments, the service may include, without limitation, all kinds of services, such as online storage services, social network services, office work support, and the like, which can be provided to a user through the network.

The terminal 102 may include a service provider application 110, an RP client 112, a biometric authentication client 114, and a terminal-side encryption module 116.

The service provider application 110 is an application used by the user to receive a service from the service provider server 104. In one embodiment, the service provider application 110 may be a web browser or a dedicated application created and distributed by a service provider.

The RP client 112 is an application for performing authentication of a user of the terminal 102 in association with the RP server 106 upon request of the service provider application 110. In the embodiments to be disclosed, the RP client 112 may perform authentication using one of online authentication and pre-online authentication according to a network state. In this case, the online authentication refers to authentication in an online state in which the terminal 102 is normally accessible to the RP server 106. In addition, the pre-online authentication refers to authentication in which the user is provisionally authenticated in an offline state in which the terminal 102 is inaccessible to the RP server 106 and then post-verification of a result of the provisional authentication in the offline state is performed when the terminal 102 switches to the online state.

In one embodiment, the RP client 112 may receive an authentication request message from the RP server 106 and perform user authentication by performing biometric authentication of the user through the biometric authentication client 114 and then transmitting a result of the biometric authentication (authentication assertion) as a response to the authentication request message to the RP server 106.

When the terminal 102 is in an offline state, the RP client 112 may generate a new authentication request message for pre-online authentication using the authentication request message received in a previous online authentication process and may request biometric authentication of the user by providing the generated new authentication request message to the biometric client 114. In this case, the authentication assertion received from the biometric authentication client 114 as the biometric authentication result is stored in the RP client 112 in the form of a file. Then, when the terminal 102 switches from an offline state to an online state, the RP client 112 transmits the pre-stored authentication assertion file to the RP server 106.

The biometric authentication client 114 perform biometric authentication of the user upon request of the RP client 112 and transmits the authentication result to the RP client 112. Specifically, the biometric authentication client 114 receives an authentication request message according to a FIDO protocol from the RP client 112 and acquires a challenge included in the authentication request message. Then, the biometric authentication client 114 extracts a private key of the user stored in a secure area of the terminal 102 upon biometric authentication of the user and signs the challenge with the extracted private key. Thereafter, the biometric authentication client 114 transmits an authentication assertion including the signature value to the RP client 112.

The terminal-side encryption module 116 encrypts or decrypts the authentication request message upon request of the RP client 112. In addition, the terminal-side encryption module 116 generates a challenge according to a challenge generation request from the RP client 112 in the process of pre-online authentication. Also, the terminal-side encryption module 116 encrypts the authentication assertion generated by the biometric authentication client 114.

The service provider server 104 is a server used to provide a service to the user of the terminal 102 in association with the service provider application 110.

The RP server 106 is a server for performing authentication of the user of the terminal 102 in association with the RP client 112. In the process of online authentication, the RP server 106 transmits the authentication request message to the terminal 102 upon request form the RP client 112. Then, the RP server 106 receives the authentication assertion from the RP client 112 and verifies the received authentication assertion in association with the biometric authentication server 108.

In the process of pre-online authentication, the RP server 106 receives the encrypted authentication assertion from the RP client 112 and decrypts the same using a server-side encryption module 118. Then, the RP server 106 verifies the decrypted authentication assertion in association with the biometric authentication server 108.

The biometric authentication server 108 generates an authentication request message for online authentication upon request from the RP server 106 and transmits the authentication request message to the RP server 106. In addition, the biometric authentication server 108 verifies the authentication assertion received from the terminal 102 upon request from the RP server 106 and provides a verification result to the RP server 106.

The server-side encryption module 118 decrypts the encrypted authentication assertion upon request from the RP server 106. In addition, the server-side encryption module 118 generates a challenge according to a challenge generation request from the biometric authentication server 108 in the process of verifying the authentication assertion.

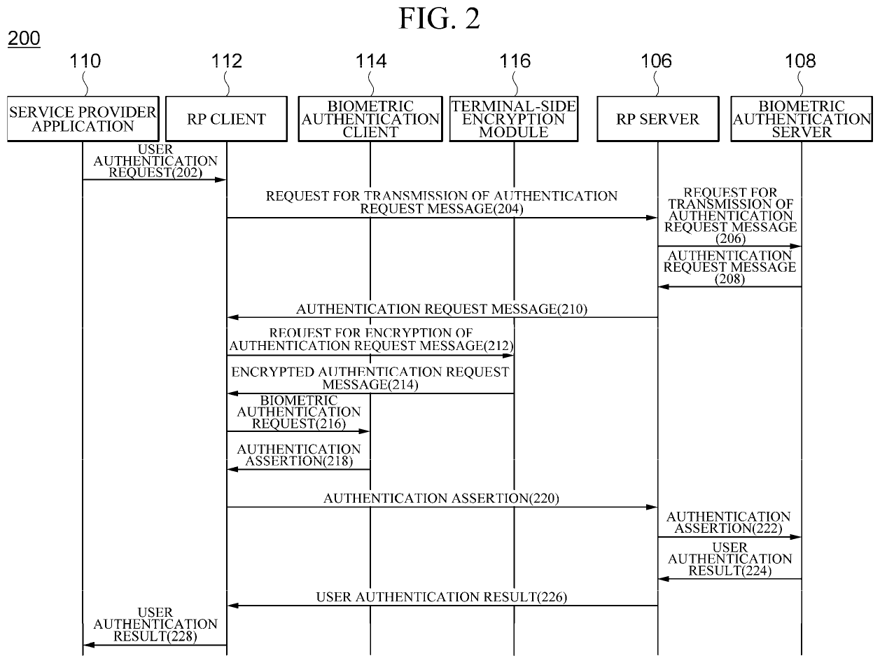

FIG. 2 is a flowchart for describing an online authentication process 200 in an authentication method according to one embodiment. In the illustrated flowchart, the method is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 202, a service provider application 110 requests an RP client 112 for user authentication.

In operation 204, the RP client 112 requests an RP server 106 to transmit an authentication request message.

In operation 206, the RP server 106 forwards the received request to a biometric authentication server 108.

In operation 208, the biometric authentication server 108 generates an authentication request message and transmits the same to the RP server 106.

In operation 210, the RP server 106 transmits the authentication request message received from the biometric authentication server 108 to the RP client 112.

In operation 212, the RP client 112 receives the authentication request message and requests a terminal-side encryption module 116 to encrypt the authentication request message.

In operation 214, the terminal-side encryption module 116 encrypts the authentication request message upon request from the RP client 112 and transmits the encrypted authentication request message to the RP client 112. Then, the RP client 112 stores therein the encrypted authentication request message. The stored encrypted authentication request message is used later in the process of pre-online authentication.

In operation 216, the RP client 112 transmits the authentication request message received from the RP server 106 to the biometric authentication client 114 to request biometric authentication.

In operation 218, the biometric authentication client 114 performs biometric authentication of the user upon request from the RP client 112 and transmits a result of the biometric authentication to the RP client 112. Specifically, the biometric authentication client 114 receives an authentication request message according to a FIDO protocol from the RP client 112 and acquires a challenge included in the authentication request message. Then, the biometric authentication client 114 extracts a private key of the user stored in a secure area of the terminal 102 upon biometric authentication of the user and signs the challenge with the extracted private key. Then, the biometric authentication client 114 transmits an authentication assertion including the signature value to the RP client 112.

In operation 220, the RP client 112 transmits the authentication assertion received from the biometric authentication client 114 to the RP server 106.

In operation 222, the RP server 106 transmits the received authentication assertion to the biometric authentication server 108 to request verification of the authentication assertion.

In operation 224, the biometric authentication server 108 verifies the authentication assertion and returns a verification result to the RP server 106.

In operation 226, the RP server 106 transmits a user authentication result in accordance with the verification result to the RP client 112.

In operation 228, the RP client 112 transmits the received user authentication result to the service provider application 110.

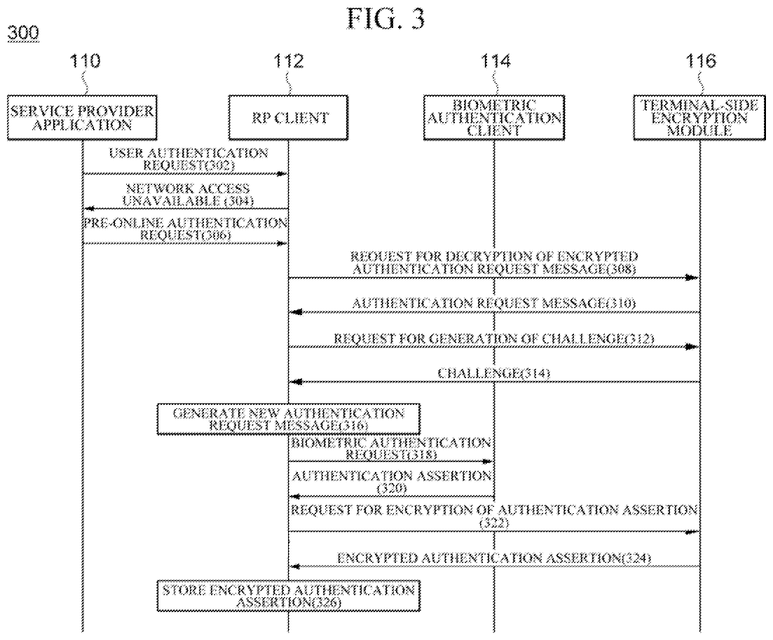

FIG. 3 is a flowchart for describing a pre-online authentication process 300 in an authentication method according to one embodiment. In the illustrated flowchart, the process is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 302, a service provider application 110 requests an RP client 112 for user authentication.

In operation 304, the RP client 112 detects an offline state in which network access is currently not possible, and notifies the service provider application 110 of the current state.

In operation 306, the service provider application 110 requests the RP client 112 for pre-online authentication.

In operation 308, the RP client 112 requests a terminal-side encryption module 116 for decryption of an encrypted authentication request message pre-stored in a previous online authentication process.

In operation 310, the terminal-side encryption module 116 decrypts the encrypted authentication request message received from the RP client 112 and transmits the decrypted authentication request message to the RP client 112.

In operation 312, the RP client 112 requests the terminal-side encryption module 116 to generate a new challenge for pre-online authentication. Specifically, the RP client 112 may extract a previous challenge used in the previous authentication process from the decrypted authentication request message. Then, the RP client 112 may request the generation of a new challenge by transmitting the previous challenge, user ID of the terminal 102, and current time (generation time of a new challenge) information to the terminal-side encryption module 116.

In operation 314, the terminal-side encryption module 116 generates a new challenge according to the new challenge generation request and transmits the new challenge to the RP client 112. Specifically, the terminal-side encryption module 116 extracts a sign count of the corresponding user by using the user ID of the terminal 102. Then, the terminal-side encryption module 116 may generate the new challenge by encrypting a string including the previous challenge, the sign count, and the generation time.

In operation 316, the RP client 112 generates a new authentication request message using the new challenge received from the terminal-side encryption module 116. Specifically, the RP client 112 may generate the new authentication request message by replacing a value of the challenge (previous challenge) included in the authentication request message acquired in operation 310 with the new challenge. In addition, the RP client 112 may add the generation time and an identifier for indicating that a current authentication type is pre-online authentication to the new authentication request message. In this case, the identifier and the generation time may be added to an extension area of the new authentication request message. For example, the following identifier and generation time may be added to the extension area of the new authentication request message.

“exts”:[

{“id”:“preonline”, “data”:1, “fail_if_unknown”:“true”},

{“id”:“time”, “data”:“2018:06:07:15:33”, “fail_if_unknown”:“true”},

]

In this example, when a value of “preonline” is 1, it indicates corresponding authentication is pre-online authentication. In addition, a value of “time” indicates a generation time of a corresponding challenge. Also, “fail_if_unknown”:“true” indicates that a corresponding extension item should be included in a signature value of the corresponding challenge in the process of biometric authentication.

In operation 318, the RP client 112 transmits the new authentication request message to a biometric authentication client 114 to request biometric authentication.

In operation 320, the biometric authentication client 114 performs biometric authentication of the user upon request from the RP client 112 and transmits a result of the biometric authentication to the RP client 112. Specifically, the biometric authentication client 114 receives the new authentication request message from the RP client 112 and acquires the challenge included in the authentication request message. Then, the biometric authentication client 114 extracts a private key of the user stored in a secure area of a terminal 102 and signs the challenge with the extracted private key. Then, the biometric authentication client 114 transmits an authentication assertion including the signature value to the RP client 112. In this case the signature value includes a pre-online mode identifier and the generation time information which are included in the extension area of the challenge.

In operation 322, the RP client 112 transmits the authentication assertion received from the biometric authentication client 114 to the terminal-side encryption module 116 to request encryption.

In operation 324, the terminal-side encryption module 116 transmits an encrypted authentication assertion to the RP client 112.

In operation 326, the RP client 112 stores therein the encrypted authentication assertion in the form of a file.

As described above, when the authentication assertion encrypted in an offline state is stored, the RP client 112 may notify the service provider application 110 of this fact. Then, the service provider application 110 may regard that the user has been authenticated, and provide a service to the user. According to one embodiment, the service provider application 110 may apply a different level of service provision to each of the online authentication and the pre-online authentication. For example, the service provider application 110 may be configured to only allow viewing of a document when the pre-online authentication is performed, and to additionally allow modification and deletion of the document when online authentication is performed. In another embodiment, the service provider application 110 may be configured to temporally grant modification right to a pre-online authenticated user for the document, locally record corresponding modifications, and afterward apply the modifications online when verification of the previous pre-online authentication is complete in an online state.

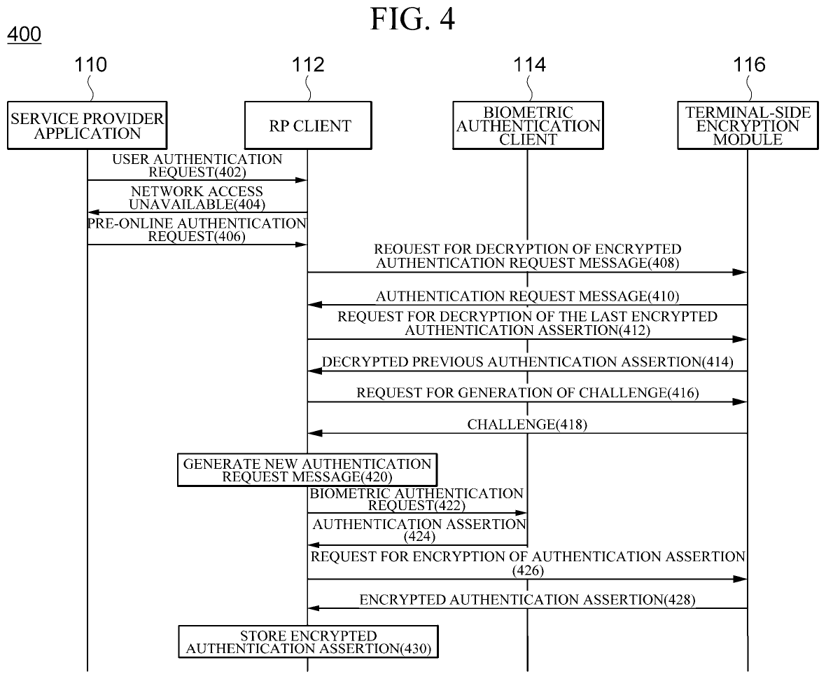

FIG. 4 is a flowchart for describing a pre-online authentication process 400 according to another embodiment, in which pre-online authentication is performed two or more times in an offline state. That is, the present flowchart illustrates a process in which pre-online authentication is performed again in a state in which one or more authentication assertions have been stored as pre-online authentication is performed one or more times before a terminal 102 switches to an online state. In the illustrated flowchart, the process is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 402, a service provider application 110 requests an RP client 112 for user authentication.

In operation 404, the RP client 112 detects an offline state in which currently network access is not possible, and notifies the service provider application 110 of this fact.

In operation 406, the service provider application 110 requests the RP client 112 for pre-online authentication.

In operation 408, the RP client 112 requests a terminal-side encryption module 116 to decrypt an encrypted authentication request message pre-stored in a previous online authentication process.

In operation 410, the terminal-side encryption module 116 decrypts the encrypted authentication request message received from the RP client 112 and transmits the decrypted authentication request message to the RP client 112.

In operation 412, the RP client 112 requests the encryption module 116 to decrypt the last authentication assertion generated and encrypted among authentication assertions generated during a previous pre-online authentication process. This is to acquire the latest challenge value from the last authentication assertion.

In operation 414, the terminal-side encryption module 116 decrypts the previous authentication assertion upon request from the RP client 112 and transmits the decrypted authentication assertion to the RP client 112.

In operation 416, the RP client 112 requests the terminal-side encryption module 116 to generate a new challenge for pre-online authentication. Specifically, the RP client 112 extracts a challenge value from the decrypted previous authentication assertion. Then, the RP client 112 may transmit the extracted challenge, user ID of the terminal 102, and the current time (generation time of the new challenge) information to the terminal-side encryption module 116 to request generation of the new challenge.

In operation 418, the terminal-side encryption module 116 generates a new challenge according to the new challenge generation request and transmits the new challenge to the RP client 112. Specifically, the terminal-side encryption module 116 extracts a sign count of the corresponding user using the user ID of the terminal 102. Then, the terminal-side encryption module 116 may generate the new challenge by encrypting a string including the previous challenge, the sign count, and the generation time.

In operation 420, the RP client 112 generates a new authentication request message using the new challenge received from the terminal-side encryption module 116. Specifically, the RP client 112 may generate the new authentication request message by replacing the challenge value included in the authentication request message acquired in operation 410 with the new challenge. In addition, the RP client 112 may add the generation time and an identifier for indicating that the current authentication type is pre-online authentication to the new authentication request message. Here, the identifier and the generation time are described with reference to FIG. 3 and thus detailed descriptions thereof will not be reiterated.

In operation 422, the RP client 112 transmits the new authentication request message to a biometric authentication client 114 to request biometric authentication.

In operation 424, the biometric authentication client 114 performs biometric authentication of the user upon request from the RP client 112 and transmits a result of the biometric authentication to the RP client 112. Specifically, the biometric authentication client 114 receives the new authentication request message from the RP client 112 and acquires a challenge included in the authentication request message. Then, the biometric authentication client 114 extracts a user's private key stored in a secure area of the terminal 102 through biometric authentication of the user and signs the challenge with the extracted private key. Thereafter, the biometric authentication client 114 transmits an authentication assertion including the signature value to the RP client 112. In this case, the signature value includes a pre-online mode identifier and the generation time information which are included in an extension area of the challenge.

In operation 426, the RP client 112 transmits the authentication assertion received from the biometric authentication client 114 to request encryption.

In operation 428, the terminal-side encryption module 116 transmits an encrypted authentication assertion to the RP client 112.

In operation 430, the RP client 112 stores therein the encrypted authentication assertion in the form of a file.

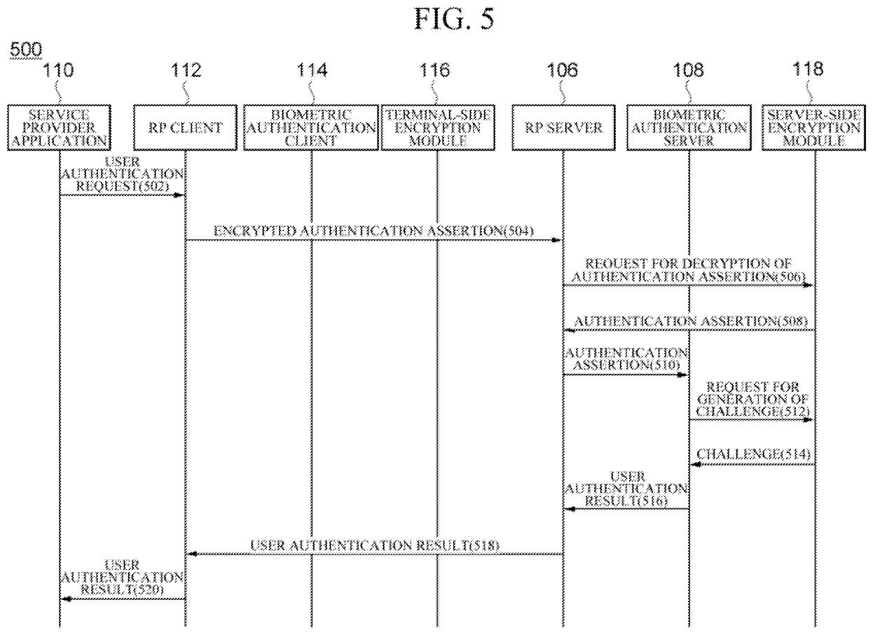

FIG. 5 is a flowchart for describing a pre-online authentication process 500 according to one embodiment, in which operations for verifying previous pre-online authentication when a terminal 102 switches from an offline state to an online state. In the illustrated flowchart, the process is described as being divided into a plurality of operations. However, it should be noted that at least some of the operations may be performed in different order or may be combined into fewer operations or further divided into more operations. In addition, some of the operations may be omitted, or one or more extra operations, which are not illustrated, may be added to the flowchart and be performed.

In operation 502, a service provider application 110 requests an RP client 112 for user authentication.

In operation 504, the RP client 112 transmits an encrypted authentication assertion generated previously during a pre-online authentication process to an RP server 106. When a plurality of pre-online authentications are performed in an offline state, the RP client 112 may transmit a plurality of encrypted authentication assertions to the RP server 106.

In operation 506, the RP server 106 transmits the received encrypted authentication assertion to a server-side encryption module 118 to request decryption.

In operation 508, the server-side encryption module 118 decrypts the received encrypted authentication assertion and transmits the decrypted authentication assertion to the RP server 106.

In operation 510, the RP server 106 transmits the decrypted authentication assertion to a biometric authentication server 108 to request verification of the authentication assertion.

In operation 512, the biometric authentication server 108 which has received the verification request requests the server-side encryption module 118 to generate a challenge for the verification. Specifically, the biometric authentication server 108 transmits a previous challenge generated in a previous online authentication process, user ID of the terminal 102, and current time (generation time of a new challenge) information to the server-side encryption module 118 to request generation of a new challenge. In this case, the generation time may be found from the decrypted authentication assertion.

In operation 514, the server-side encryption module 118 generates a new challenge according to the new challenge generation request and transmits the new challenge to the biometric authentication server 108. Specifically, the server-side encryption module 118 extracts a sign count of the corresponding user using user ID of the terminal 102. Then, the server-side encryption module 118 may generate the new challenge by encrypting a string including the previous challenge, the sign count, and a generation time.

In operation 516, the biometric authentication server 108 verifies the authentication assertion using the generated new challenge and transmits a verification result to the RP server 106. Specifically, the biometric authentication server 108 may verify the authentication assertion by comparing the generated new challenge with the challenge included in the authentication assertion. When there are a plurality of authentication assertions received from the terminal 102, the biometric authentication server 108 may sequentially generate a new challenge according to the generation order of each authentication assertion and verify each of the new challenges by comparing the new challenge with a challenge recorded in the corresponding authentication assertion. Due to the characteristic of the FIDO protocol, in order to generate a new challenge, a previous challenge value is needed as one of the elements of the new challenge. Therefore, the biometric authentication server 108 may sequentially generate the next challenge using a challenge included in the first generated authentication assertion among a plurality of authentication assertions and may verify each authentication assertion using the generated challenge.

In operation 518, the RP server 106 transmits an authentication result for the user of the terminal 102 to the RP client 112 on the basis of a result of the authentication assertion verification.

In operation 520, the RP client 112 forwards the received authentication result to the service provider application 110. At this time, previously transmitted assertions are deleted.

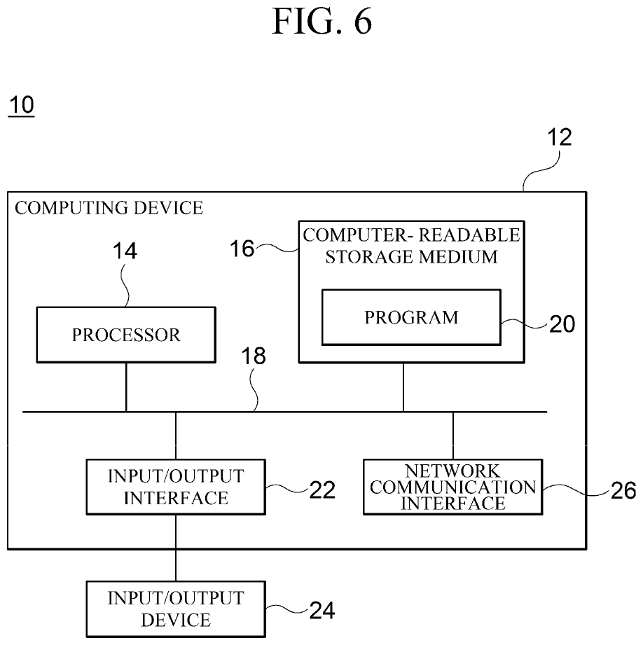

FIG. 6 is a block diagram for describing a computing environment 10 including a computing device suitable to be used in exemplary embodiments. In the illustrated embodiments, each of the components may have functions and capabilities different from those described hereinafter and additional components may be included in addition to the components described herein.

The illustrated computing environment 10 includes a computing device 12. In one embodiment, the computing device 12 may be a terminal 102, a service provider server 104, an RP server 106, or a biometric authentication server 108 in accordance with the embodiments of the present disclosure. The computing device 12 may include at least one processor 14, a computer-readable storage medium 16, and a communication bus 18. The processor 14 may cause the computing device 12 to operate according to the above-described exemplary embodiment. For example, the processor 14 may execute one or more programs stored in the computer-readable storage medium 16. The one or more programs may include one or more computer executable commands, and the computer executable commands may be configured to, when executed by the processor 14, cause the computing device 12 to perform operations according to the exemplary embodiment.

The computer readable storage medium 16 is configured to store computer executable commands and program codes, program data and/or information in other suitable forms. The program 20 stored in the computer readable storage medium 16 may include a set of commands executable by the processor 14. In one embodiment, the computer readable storage medium 16 may be a memory (volatile memory, such as random access memory (RAM), non-volatile memory, or a combination thereof), one or more magnetic disk storage devices, optical disk storage devices, flash memory devices, storage media in other forms capable of being accessed by the computing device 12 and storing desired information, or a combination thereof.

The communication bus 18 connects various other components of the computing device 12 including the processor 14 and the computer readable storage medium 16.

The computing device 12 may include one or more input/output interfaces 22 for one or more input/output devices 24 and one or more network communication interfaces 26. The input/output interface 22 and the network communication interface 26 are connected to the communication bus 18. The input/output device 24 may be connected to other components of the computing device 12 through the input/output interface 22. The illustrative input/output device 24 may be a pointing device (a mouse, a track pad, or the like), a keyboard, a touch input device (a touch pad, a touch screen, or the like), an input device, such as a voice or sound input device, various types of sensor devices, and/or a photographing device, and/or an output device, such as a display device, a printer, a speaker, and/or a network card. The illustrative input/output device 24, which is one component constituting the computing device 12, may be included inside the computing device 12 or may be configured as a device separate from the computing device 12 and be connected to the computing device 12.

According to the above-described embodiments, user authentication is performed by applying a FIDO protocol in an offline environment where online access is not possible, and later the previous authentication performed in the offline environment is verified when the offline environment switches to an online environment, so that user's convenience can be improved.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An authentication method performed by a terminal device comprising a processor that executes a program stored in a memory, the authentication method comprising:
storing a first authentication request message received from an authentication server;
generating a new challenge using a previous challenge used in a previous authentication process when a network connection to the authentication server is not possible;
generating a second and newer authentication request message by replacing a challenge included in the first authentication request message with the new challenge;
generating an authentication assertion by performing biometric authentication using the second authentication request message; and
storing the generated authentication assertion.

2. The authentication method of claim 1, wherein the generating of the new challenge comprises encrypting a string including the previous challenge, a sign count corresponding to the terminal device, and a generation time of the new challenge.

3. The authentication method of claim 2, wherein the generating of the second authentication request message further comprises adding the generation time and an identifier indicating that a current authentication type is pre-online authentication to the second authentication request message.

4. The authentication method of claim 3, wherein the identifier and the generation time are added to an extension area of the second authentication request message.

5. The authentication method of claim 1, wherein when a previously generated authentication assertion does not exist in the terminal device, the generating of the new challenge further comprises extracting the previous challenge from the stored first authentication request message.

6. The authentication method of claim 1, wherein when there are a plurality of previously generated authentication assertions within the terminal device, the generating of the new challenge further comprises extracting the previous challenge from a last authentication assertion from among the plurality of previously generated authentication assertions.

7. The authentication method of claim 1, wherein the storing of the authentication assertion further comprises encrypting the authentication assertion.

8. An authentication method performed by a server device comprised of a processor that executes a program stored within a memory, the authentication method comprising:
receiving, from a terminal, an authentication assertion for authentication of a user of the terminal;
generating a new challenge using time information included in the authentication assertion and a previous challenge used in a previous authentication process with the terminal;
verifying the authentication assertion using the new challenge; and
transmitting an authentication result for the user of the terminal to the terminal based upon the verifying of the authentication assertion.

9. The authentication method of claim 8, wherein the received authentication assertion is encrypted, wherein the method further comprises decrypting the encrypted authentication assertion upon the receiving of the authentication assertion.

10. The authentication method of claim 8, wherein the receiving of the authentication assertion comprises receiving a plurality of authentication assertions, the generating the new challenge and the verifying of the authentication assertion being repeated sequentially according to a generation order of the plurality of authentication assertions.

11. A terminal device, comprising:
a processor;
a memory; and
a program including a plurality of instructions stored within the memory, the processor to execute the instructions to perform a method comprising:
storing a first authentication request message received from an authentication server;
generating a new challenge using a previous challenge used in a previous authentication process when a network connection to the authentication server is not possible;
generating a second and newer authentication request message by replacing a challenge included in the first authentication request message with the new challenge;
generating an authentication assertion by performing biometric authentication using the second authentication request message; and
storing the generated authentication assertion.

12. The terminal device of claim 11, wherein the generating of the new challenge comprises encrypting a string including the previous challenge, a sign count corresponding to the terminal device, and a generation time of the new challenge.

13. The terminal device of claim 12, wherein the generating of the second authentication request message further comprises adding the generation time and an identifier indicating that a current authentication type is pre-online authentication to the second authentication request message.

14. The terminal device of claim 13, wherein the identifier and the generation time are added to an extension area of the second authentication request message.

15. The terminal device of claim 11, wherein when a previously generated authentication assertion does not exist in the terminal device, the generating of the new challenge further comprises extracting the previous challenge from the stored first authentication request message.

16. The terminal device of claim 11, wherein when there are a plurality of previously generated authentication assertions within the terminal device, the generating of the new challenge further comprises extracting the previous challenge from a last authentication assertion from among the plurality of authentication assertions.

17. The terminal device of claim 11, wherein the storing of the authentication assertion further comprises encrypting the authentication assertion.

18. A server device, comprising:
a processor;
a memory; and
a program including a plurality of instructions stored within the memory, wherein the processor executes the instructions to perform a method comprising:
receiving, from a terminal, an authentication assertion for authentication of a user of the terminal;
generating a new challenge using time information included in the authentication assertion and a previous challenge used in a previous authentication process with the terminal;
verifying the authentication assertion using the new challenge; and
transmitting an authentication result for the user of the terminal to the terminal based upon the verifying of the authentication assertion.

19. The server device of claim 18, wherein the received authentication assertion is encrypted, wherein the method further comprises decrypting the encrypted authentication assertion.

20. The server device of claim 18, wherein when the receiving of the authentication assertion comprises receiving a plurality of authentication assertions, the generating the new challenge and the verifying of the authentication assertion are repeated sequentially according to a generation order of the plurality of authentication assertions.
